(19) United States
(12) Patent Application Publication
(10) Pub. No.: US 2018/0075543 A1
(43) Pub. Date: Mar. 15, 2018

(54) SYSTEM AND METHOD FOR OPTIMIZING FLEET OPERATION AT MINING SITE

(71) Applicant: Caterpillar Inc., Peoria, IL (US)

(72) Inventors: Kiriaco Rodrigo Dario Jarami Orellana, Taringa (AU); John Steven Harpour, Thornlands (AU); Scott Andrew Kirkman, Camp Hill (AU); Thomas Frank Doherty, Holland Park (AU)

(21) Appl. No.: 15/260,817

(22) Filed: Sep. 9, 2016

(51) Int. Cl. G06Q 50/02; G06Q 10/06

(52) U.S. Cl. CPC G06Q 50/02; G06Q 10/06315

(57) ABSTRACT

A system and method of optimizing fleet operation at a mining site is provided. The system includes a non-transitory computer readable medium storing a program causing a computer to execute steps of identifying a forthcoming dig area including material to be extracted by a digging tool, assigning at least one quantified material characteristic to the material to be extracted, and assigning a truck movement based on the at least one quantified material characteristic. The at least one quantified material characteristic of the extracted material is used to assign truck movement, including material flow to processors.

### TECHNICAL FIELD

The present disclosure relates generally to a system and method for optimizing fleet operation at a mining site based on a quantified material characteristic, and more particularly to forecasting the quantified material characteristic in a forthcoming dig area to manage truck movement.

### BACKGROUND

Mining operations vary in size and complexity, but generally involve the extraction of geological materials, such as ores, from the ground. Various mining techniques exist, including underground mining and, more commonly, surface mining In all techniques, heavy equipment, or machinery, is used to develop mining sites, and extract and process the geological materials. Heavy equipment is also used to transport the extracted material at the mining site and from the mining site to various locations. Modern engineering and technology have contributed to improvements in all phases of mining operations, including improvements to machinery and to the mining process itself.

U.S. Patent Application Publication No. 2016/0016202 to Bamber et al. discloses a mining shovel having a bucket with inwardly facing compositional sensors. Processing equipment receives and analyzes data from the sensors, and generates instructions directing where to deposit material located in the bucket based on the data collected from the sensors.

As should be appreciated, there is a continuing need to improve efficiency and productivity in mining operations.

### SUMMARY OF THE INVENTION

In one aspect, a system for optimizing fleet operation at a mining site includes a non-transitory computer readable medium storing a program causing a computer to execute various steps. The steps include identifying a forthcoming dig area including material to be extracted by a digging tool, assigning at least one quantified material characteristic to the material to be extracted, and assigning a truck movement based on the at least one quantified material characteristic.

In another aspect, a method of optimizing fleet operation at a mining site is provided. The method includes steps of identifying a forthcoming dig area including material to be extracted by a digging tool, assigning at least one quantified material characteristic to the material to be extracted, and assigning a truck movement based on the at least one quantified material characteristic.

### BRIEF DESCRIPTION OF THE DRAWINGS

FIG. 1 is a schematic diagram of an exemplary system for optimizing fleet operation at a mining site, according to the present disclosure;

FIG. 2 is an exemplary 3D view of a mining block with voxels, as represented in a computer environment, according to one aspect of the present disclosure;

FIG. 3 is an exemplary 3D geological model of the mining block of FIG. 2; and

FIG. 4 is a flow diagram representing a method for optimizing fleet operation at a mining site.

### DETAILED DESCRIPTION

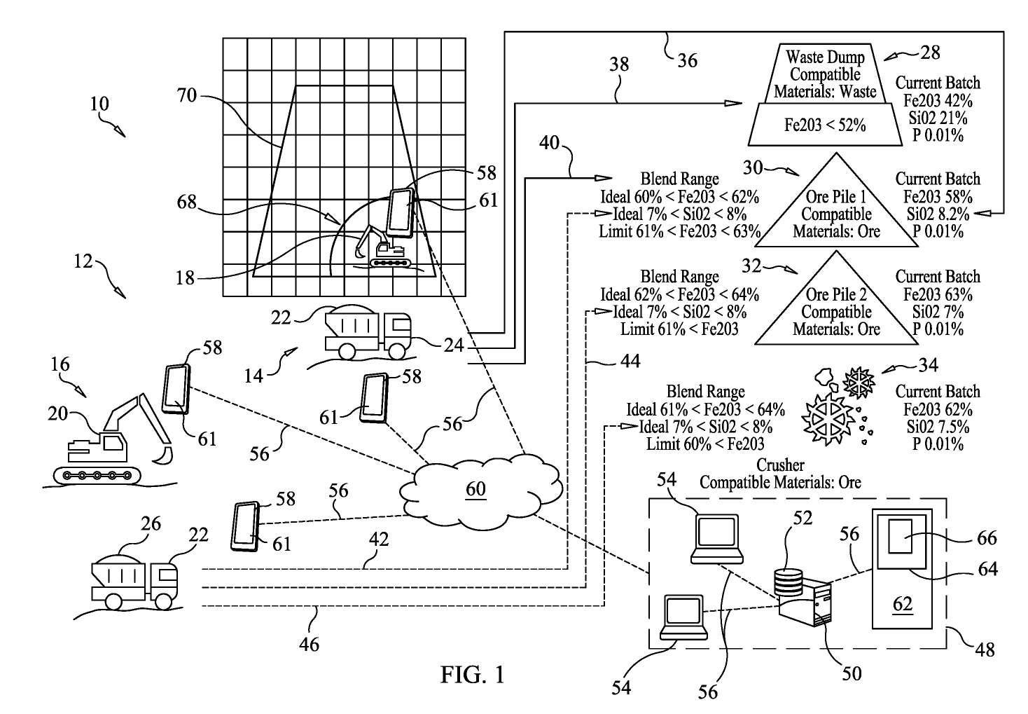

An exemplary system for optimizing fleet operation is shown generally at 10 in FIG. 1. The system 10 is provided for a mining site 12, which includes one or more digging locations 14 and 16 from which respective excavators, or digging tools, 18 and 20 remove material 22. The system 10 also includes mining trucks 24 and 26 for transporting extracted material 22 from the digging locations 14 and 16 to one or more processing locations 28, 30, 32 and 34. For example, mining truck 24 may transport extracted material 22 along one of truck paths 36, 38 and 40, corresponding to one forecasted dig path, while mining truck 26 may transport extracted material 22 along one of truck paths 42, 44 and 46, corresponding to a different forecasted dig path. It should be appreciated that mining site, or area, 12 may include additional and/or alternative components and may vary in complexity, depending on the particular application.

The system 10 may also include a mining operations system 48, which may be located on-site or off-site. The mining operations system 48 may include, among a number of additional and/or alternative components, a server, or computer, 50, a database 52, and a first plurality of user devices 54. The first plurality of user devices 54 may communicate directly or indirectly with other components of the mining operations system 48 using a local, private or public network. However, it should be appreciated that various wired and/or wireless communication schemes may be used that incorporate various conventional communication protocols and/or data port interfaces. Communication links are shown generally at 56 to represent exchange of information between components, regardless of the communication scheme that is utilized.

A second plurality of user devices 58 may also access the mining operations system 48 through a public network 60, such as the Internet. However, local or private networks may alternatively be used. The second plurality of user devices 58 may be provided onboard equipment or machines, such as excavators 18 and 20 and mining trucks 24 and 26, at the mining site 12. Any or all of the user devices 54 and 58 may be electronic devices, such as, for example, desktop computers, laptop computers, smartphones, or tablets. The user devices 54 and 58 may each include one or more of a central processing unit, memory, display functionality and operating system that runs programs and/or apps for performing different functions. According to some embodiments, the second plurality of user devices 58 may include one of an onboard visualization tool 61 and/or a virtual or augmented reality view, which may be displayed or presented on a heads up display.

The server 50 may include applications, or programs, pertaining to the system 10. The server 50 may be referenced as a computer and may include one or more devices having one or more processors, memory, storage, a display, a network interface, and an input/output device, for example. The processor, processors, may execute unique sets of instructions, which may be implemented as computer readable program code, stored in memory or storage, such that the server 50 is configured as a special purpose system.

In particular, hardware, software, and particular sets of instructions may transform the server 50 into at least a portion of the system 10. As should be appreciated by those skilled in the art, the server 50 may include, in addition to hardware components, an application layer and an interface layer that may include or provide a variety of user interfaces permitting direct or indirect interaction between the server 50 and the user devices 54 and 58.

Among other modules, the server, or computer, 50 may include a mining operations module 62. It should be appreciated that the use of the term “module” is for ease of explanation, rather than limitation, and is intended to represent certain related aspects of functionality of the system 10. The mining operations module 62 may include a non-transitory computer readable medium 64 storing a program 66, or computer readable program code, representing processes for performing specific tasks of the system 10. The tasks may be performed using a processor, or processors, and may require the access and/or manipulation of data stored in one or more databases, such as database 52.

The program 66 may cause the server, or computer, 50 to identify a forthcoming dig area 68 of a current mining block 70. The forthcoming dig area 68 may be identified based on a predetermined time period, such as, for example, thirty minutes, of digging and/or may be based on a predicted tool path. The predicted tool path may be received by an operator input or may be based on a previous digging area, which may be obtained by the program 66. The program 66 may utilize various algorithms to forecast the forthcoming dig area 68.

The program 66 may also cause the server 50 to assign at least one quantified material characteristic to the material to be extracted in the forthcoming dig area 68, as will be described below, and assign a truck movement, or truck path, based on the at least one quantified material characteristic of the material to be extracted.

That is, the program 66 may seek to manage truck movement in an efficient manner that ensures material having similar material characteristics, such as grade or quality, are taken to the same processing location 28, 30, 32, or 34. The truck movements may include selection of one of the truck paths 36, 38, and/or 40 based on the at least one quantified material characteristic of the material to be extracted from a forthcoming dig area 68. Selection of one of the truck paths 42, 44, and/or 46 may be based on a quantified material characteristic of material to be extracted from an alternative or modified forthcoming dig area 68.

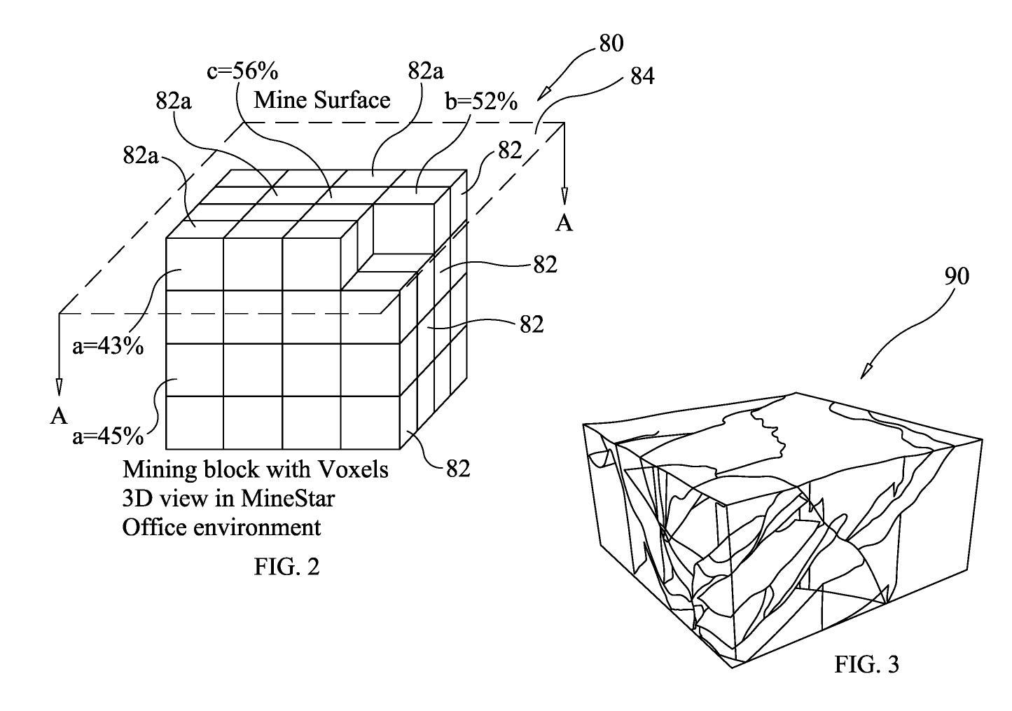

Turning now to FIG. 2, the program 66 may cause the server, or computer, 50 to provide a voxel representation 80 of the mining area 12. The voxel representation 80 may include a plurality of voxels 82, and may be provided for all or portions of the mining area 12. The voxel representation 80 and the voxels 82 may vary in size and/or shape. The size and/or shape of each of the plurality of voxels 82 may or may not be the same. Voxels 82a represent a set of the voxels 82 that intersect a mining surface 84 of the mining area 12. The material characteristics of the voxels may be selected for the forthcoming dig area 68.

The program 66 may further cause the server, or computer 50 to compare at least one of the voxels 82 to a geological model 90 of the mining area 12. The geological model 90 may be created or provided using a software tool, such as, for example, MineStar, a suite of mining technology products from Caterpillar of Peoria, Ill. The geological model 90 is essentially a spatial representation of the distribution of sediments and rocks in the subsurface for the area corresponding to the mining area 12.

The program 66 may then assign at least one quantified material characteristic, such as, for example, a, b, and c, to the voxels 82 based on the geological model 90 of the mining area 12. Further, the program 66 may assign a visual indicator, such as color or shading, to each voxel 82 based on the at least one quantified material characteristic a, b, or c. This may include assignment of one of different visual indicators to the voxels 82. For example, voxels 82 having material grades less than 50% will be shown in a first color or pattern, while voxels 82 having material grades between 51% and 55% will be shown in a second color or pattern, and voxels 82 having material grades between 56% and 60% will be shown in a third color or pattern. The material characteristics, such as a, b, and c, may represent material grade or quality or other desired material characteristic.

### INDUSTRIAL APPLICABILITY

The present disclosure relates generally to a system for optimizing fleet operation at a mining site. More particularly, the present disclosure relates to the optimization of truck movements, or paths, based on characteristics of extracted material. Yet further, the present disclosure is related to identifying a forthcoming dig area, and assigning truck movements based on material characteristics of the forthcoming dig area.

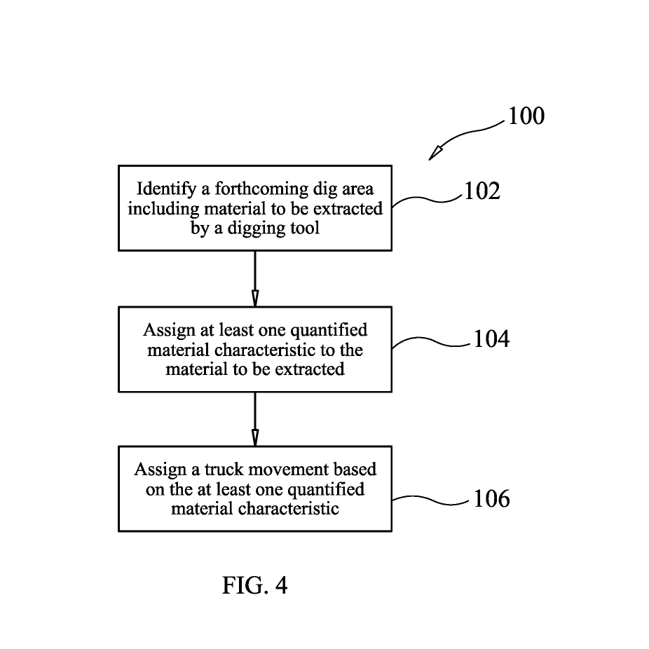

Referring generally to FIGS. 1-4, a mining operations system 48 may include non-transitory computer readable media 64 storing a program 66. The program 66 may cause a computer, such as server 50, to execute various steps to perform various actions. According to an exemplary embodiment, a method, illustrated as a flow diagram 100 in FIG. 4, may be implemented in whole or in part by the server 50. All or portions of the method may run continuously or intermittently, such as at predetermined intervals. In box 102, a forthcoming dig area 68 including material to be extracted 22 by a digging tool 18 is identified.

At box 104, at least one quantified material characteristic is assigned to the material to be extracted 22. For example, a voxel representation 80 of the mining area 12 may be provided. At least one voxel 82 may be compared to a geological model 90 of the mining area 12, and at least one quantified material characteristic may be assigned to the voxel 82 and, thus, the material to be extracted 22 from the forthcoming dig area 68 based on the geological model 90. A truck movement is then assigned based on the at least one quantified material characteristic.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. A system for optimizing fleet operation at a mining site including a non-transitory computer readable medium storing a program causing a computer to execute steps of:
identifying a forthcoming dig area including material to be extracted by a digging tool;
assigning at least one quantified material characteristic to the material to be extracted; and
assigning a truck movement based on the at least one quantified material characteristic.

2. The system of claim 1, wherein the program additionally causes the computer to identify the forthcoming dig area based on a predicted tool path.

3. The system of claim 2, wherein the program additionally causes the computer to identify the forthcoming dig area based on a predetermined time period of digging.

4. The system of claim 2, wherein the program additionally causes the computer to receive the predicted tool path by an operator input.

5. The system of claim 2, wherein the program additionally causes the computer to identify the predicted tool path based on a previous digging area.

6. The system of claim 1, wherein the program additionally causes the computer to assign the at least one quantified material characteristic to the material to be extracted based on a geological model of the mining area.

7. The system of claim 6, wherein the program additionally causes the computer to select the truck path based on a material grade of the material to be extracted.

8. The system of claim 6, wherein the program additionally causes the computer to select the truck path based on a material quality of the material to be extracted.

9. The system of claim 1, wherein the program additionally causes the computer to provide a voxel representation of the mining area, and assign the quantified material characteristic to the material to be extracted based on the voxel representation.

10. The system of claim 9, to select the truck path based on at least one of a material quality and a material grade of the material to be extracted.

11. A method of optimizing fleet operation at a mining site, including steps of:
identifying a forthcoming dig area including material to be extracted by a digging tool;
assigning at least one quantified material characteristic to the material to be extracted; and
assigning a truck movement based on the at least one quantified material characteristic.

12. The method of claim 11, further including identifying the forthcoming dig area based on a predetermined time period of digging.

13. The method of claim 12, further including identifying the forthcoming dig area based on a predicted tool path.

14. The method of claim 13, further including receiving the predicted tool path by an operator input.

15. The method of claim 13, further including identifying the predicted tool path based on a previous digging area.

16. The method of claim 11, further including selecting a truck path from the digging tool to a processing location based on the at least one quantified material characteristic.

17. The method of claim 16, further including selecting the truck path based on a material grade of the material to be extracted.

18. The method of claim 16, further including selecting the truck path based on a material quality of the material to be extracted.

19. The method of claim 11, further including assigning the at least one quantified material characteristic to the material to be extracted based on a geological model of the mining area.

20. The method of claim 11, further including providing a voxel representation of the mining area, and assigning the quantified material characteristic to the material to be extracted based on the voxel representation.
